(19) United States
(12) Patent Application Publication
(10) Pub. No.: US 2024/0300822 A1
(43) Pub. Date: Sep. 12, 2024

(54) METHOD OF PRODUCING IN-SITU CARBON COATED LITHIUM IRON PHOSPHATE CATHODE MATERIAL FOR LITHIUM-ION BATTERIES AND THE PRODUCT THEREOF

(71) Applicant: INTERNATIONAL ADVANCED RESEARCH CENTRE FOR POWDER METALLURGY AND NEW MATERIALS (ARCI), Gurgaon, Haryana (IN)

(72) Inventors: Srinivasan ANANDAN, Hyderabad, Telangana (IN); Ravula VIJAY, Hyderabad, Telangana (IN); Tata Narasinga RAO, Hyderabad, Telangana (IN)

(73) Assignee: INTERNATIONAL ADVANCED RESEARCH CENTRE FOR POWDER METALLURGY AND NEW MATERIALS (ARCI), Gurgaon, Haryana (IN)

(21) Appl. No.: 18/254,730

(22) PCT Filed: Dec. 6, 2021
(86) PCT No.: PCT/IN2021/051138

§ 371 Date: May 26, 2023

(30) Foreign Application Priority Data
Dec. 28, 2020 (IN) 202011056608

(51) Int. Cl. C01G 49/00; H01M 4/02; H01M 4/36; H01M 10/0525

(52) U.S. Cl. CPC C01G 49/009; H01M 4/366; H01M 10/0525; C01P 2002/01; C01P 2002/72; C01P 2002/82; C01P 2002/85; C01P 2004/03; C01P 2004/04; C01P 2004/32; C01P 2004/62; C01P 2004/84; C01P 2006/11; C01P 2006/12; C01P 2006/40; H01M 2004/028

(57) ABSTRACT

A method of producing high performance carbon coated LiFePO4 powders for making the battery grade cathode for lithium ion battery, comprising the steps of: a) mixing of Li2CO3, FeC2O4, and NH4H2PO4 precursors with different concentrations (3-10%) of citric acid in a stoichiometric ratio of 1.05:1:1; b) adding 2 to 5% stearic acid; c) milling in a attrition milling unit maintained with the ball to powder ratio of 10:1-12:1 at 250-550 rpm for 2-12 hrs; d) repeating the process of milling by increasing and decreasing the speed for a period of 2 to 24 hrs; e) discharging the milled powders on completion of milling; f) pelletizing them; g) annealing of them under argon atmosphere in large scale furnace at a temperature of 650-700° C. with a heating rate of 2-5° C./min for 2-10 hrs; and h) grinding the annealed pellets to a fine powder.

### FIELD OF INVENTION

The present invention relates to a rapid, simple and cost-effective process to prepare in-situ carbon coated LiFePO₄ (C-LFP) in large scale by adopting solid-state high-energy attrition milling technique. It is an efficient electrode material for various energy storage applications including Li-ion battery application. This is achieved by employing annealing of attritor milled Li(Li₂CO₃), Fe (FeC₂O₄), P (NH₄H₂PO₄), and C (C₆H₈O₇) precursors at high temperature (650-700° C.). The powder obtained from attritor milling were pelletized followed by carbonizing at low temperature (350-400° C.) and subsequently heated at high temperature (650-700° C.) to produce highly crystalline carbon coated LFP(C-LFP) with smaller particle size and is a cathode material for Li-ion battery application. The C-LFP so developed shows promising electrochemical properties in terms of high charge discharge capacity, excellent rate capability and long cyclic stability and hence it may be suitable for high energy as well as high power density lithium-ion battery application. The method developed for synthesizing C-LFP in this invention has the advantage of being cost effective, single step, and fast processing due to high kinetic energy system used for milling of powders.

### BACKGROUND OF THE INVENTION

Among the cathode materials reported, LFP which was introduced in 1997 by Goodenough's group (A. K. Padhi et al J. Electrochem. Soc. 144, 1997, 1188; A. K. Padhi et al J. Electrochem. Soc. 144, 1997, 2581) is considered an excellent candidate due to its intriguing features like high theoretical capacity (˜ 170 mA h g⁻¹), single voltage plateau (3.45 V vs. Li⁺/Li)), non-toxic (cobalt free), safety, structural stability, environmental friendliness economic viability, and long cycle life (Chung et al Nat. Mater. 1, 2002, 123). The high thermal stability of LFP is excellent without exothermic reactions up to 400° C. Despite many advantages, the usage of LFP is hampered by low intrinsic electronic conductivity (10⁻⁹ S cm⁻¹) and low ionic conductivity (10⁻⁸-10⁻⁷ cm² s⁻¹) (Piana et al Ionics (Kiel). 8, 2002, 17). The limited diffusion pathway restricts lithium-ion diffusion coefficient in the order of 10⁻¹⁴ to 10⁻¹⁶ cm² s⁻¹. Several efforts including (a) doping/mixing with metal ion (Croce et al Electrochem. Solid State Letters, 5, 2002, A47-A50) (b) reducing the particle size (Yamada et al J. Electrochem. Soc., 148, 2001, A224) and (c) carbon coating (Ravet et al The Electrochemical Society and Electrochemical Society of Japan Meeting Abstract, 99-2, 1999; Huang et al, Electrochem. Solid State Lett., 2001, 4, A170) have been made to alleviate these intrinsic defects. Among these efforts put forward to overcome the intrinsic limitations, carbon coating one of the most effective techniques to improve the specific capacity, rate performance and cycle life of LFP. The main role of carbon coating is to enhance the surface electronic conductivity so that the active materials can be fully utilized at high current rates. Carbon coating not only improves the electronic conductivity, but also prevents metal ion dissolution, avoids direct contact of electrolyte with active material, restricts crystal growth and act as reducing agent to suppress the oxidation of Fe²⁺ to Fe³⁺ during sintering. The influence of carbon coating has observed to depend on the structure, uniformity, thickness, loading and precursor of the coating. In general, carbon coating is carried out by either in-situ (Lin et al J. Power Sources 184, 2008, 444) or ex-situ carbon coating process (Wang et al J. Power Sources 184, 2008, 633). In the case of in-situ synthesis, carbon precursors are introduced during the synthesis of LFP whereas in the case of ex-situ process, LFP is post-treated with carbon precursors to form the carbon coating i.e., adding carbon precursors into the synthesized electrode materials followed by heat treatment to obtain carbon coating on electrode materials. Considering the single step and simplicity involved in the process, in-situ carbon coating found to be an ideal process suitable for commercial applications. Hence, in the present invention, in-situ solid state technique was employed to find the appropriate carbon coating process for improving the electrochemical properties of LFP cathode material.

Though many methods have reported to synthesize LFP, the factors such as cost, scalability and simplicity of material technology determine its commercial viability. Considering the above, in the present invention, we have adopted a sustainable and scalable low cost, energy efficient and one step solid state method for the synthesis of LFP that can be suitable for lithium-ion batteries based electric vehicle. Since it is a single step large scale process devoid of solvents and large number of precursors, it may be considered as potential process for commercial application.

Prior-art patents as well as non-patent literature related to the field of present invention available in public domains are discussed below.

CN101607702A invention provides a method for preparing lithium iron phosphate by two step processes using FeC₂O₄, lithium carbonate, ammonium phosphate, glucose as the source of Fe, Li, P and C respectively. In the first step involved mixing of lithium carbonate, a part of ammonium dihydrogen phosphate in deionized water and subsequent stirring for 2 hr. In the second step, the above mixture was mixed with FeC₂O₄, with remaining ammonium dihydrogen phosphate, glucose and industrial alcohol with zirconium balls in high-speed ball mill and ran for 6 hrs. Later, the milled raw materials were dried in oven at 60° C. for 8 hrs and subsequent sintering at 750° C. at heating rate of 10° C./min for 18 hrs. The resulting C—LiFePO₄ delivers specific capacity of 125 mAh/g.

CN104752717B invention provides a wet chemical method for preparing lithium iron phosphate using ferrous sulfate, phosphoric acid, and a lithium hydroxide as a source for Fe, P and Li respectively. The method involved atomizing and mixing an aqueous solution A containing the divalent iron source and phosphorus source and an aqueous solution B containing the lithium source, and the atomization rate of the aqueous solution A and the aqueous solution B during the atomization process is maintained to control the pH value of the mixed product at 5-7.5. The method for preparing C-LFP further also includes mixing the reaction product with an organic carbon source (citric acid) and spray-drying, and then firing to 180° C. at a heating rate of 1.3° C./min for 5 hrs and subsequent carbonization at high temperature to obtain C-LFP.

CN100567143C invention provides a wet chemical method for synthesizing LiFePO₄. In this method, first step involved is the mixing of Fe, P and carbon source, which forms precipitate with inclusion of H₂O₂. After drying, the solid precipitate was ball milled with Li source for 2 hrs and then sintered at a temperature 100-750° C. for 10-25 hrs under an inert gas and/or a reducing gas at heating rate of 2-4° C./min. The resulting LFP shows discharge capacity of ˜146 mAh/g.

CN102208618A invention provides a wet chemical method for producing a lithium iron phosphate with high conductivity and stable structure. LiFePO₄ is prepared in wet chemical process. Initially, FePO₄ was prepared by mixing of ammonium dihydrogen phosphate, ferric chloride and organic monomer (aniline) by maintaining pH 4-6. Later, the above prepared FePO₄ ball milled with lithium acetate followed by heating at 400-700° C. for 12-30 hrs at a heating at a rate of 1-10° C./min under an inert atmosphere. The highest discharge specific capacity obtained for LFP is 159 mAh/g.

CN102795611A invention provides a method for synthesizing LiFePO₄ by a wet chemical process. This method involved, preparation of iron phosphate in an alcohol solution and lithium acetate in an alcohol solution separately and subsequent mixing of the two solutions, followed by reaction in a reducing gas atmosphere or by adding a reducing agent results in LFP after the reaction is completed. Further, the addition of glucose in an alcohol solution with the above mixture and subsequent stirring with a high-speed shear disperser for 10 min., vacuum drying at 100° C., and then sintering under the protection of nitrogen at 700° C. for 8 hours also results LFP powder material. The highest discharge specific capacity obtained for C-LFP is 164 mAh/g.

CN1030224258B invention provides a solid-liquid combined method for the preparation of lithium iron phosphate. The method involved (i) preparation of mixed solution by dissolving lithium hydroxide and cellulose in water, and then add cellulose for reaction to obtain a mixed solution, (ii) addition of FePO₄ to the above mixed solution to make a slurry, and then spray-drying at a temperature of 180 ˜220° C. and sintering at 700° C. ±100° C. for 6-8 h to obtain a lithium iron phosphate material. The LFP synthesized in the present invention shows discharge specific capacity of 164 mAh/g with good rate capability.

CN105293458A invention provides a combined wet chemical and spray drying method for the synthesis of C-LFP, which includes (i) the synthesis of ferrous phosphate by spray drying of mixed solution (pH is 9 to 9.5) containing metal iron powder, phosphoric acid solution and lithium hydroxide solution at temperature range of 120 to 240° C., (ii) addition of carbon source with lithium ferrous phosphate, and subsequent sintering at 650 to 750° C. for 4 to 16 hours under oxygen-free conditions. The resulting C-LFP delivers discharge specific capacity of 165 mAh/g.

The various techniques reported in prior art adapts a method of wet chemical/solid-state (wet and dry milling)/spray drying/precipitation or combination of either one or two techniques. In most of the inventions, laboratory ball milling having the overall capacity of few hundred grams of materials was used. Further, the method of synthesis involved mixing of raw materials, use of solvents, filtration & drying of material and subsequent multi-step heating process for long time. Moreover, reactants such as lithium hydroxide, lithium chloride, FePO₄, etc., used in this method are expensive and also, most of the methods are based on an inorganic/organic solvent. Accordingly, manufacturing costs are high and thus commercialization of this method has not been realized. On the other hand, the method of the instant invention involves a simple milling of solid raw materials using attrition high energy milling technique, compaction of powder and heating of pellet at high temperature without using any solvent, thus make the process more economic which is attractive for commercial application.

Yan et al [Electrochimica Acta 54 (2009) 5770-5774] discloses a method of production of carbon coated LiFePO₄ composite. In this invention, FeC₂O₄·2H₂O and LiH₂PO₄ used as raw material for Fe and Li & P respectively and citric acid used a s raw material for carbon. The synthesis of C-LFP in this invention involves the wet planetary ball milling of raw materials (Li, Fe, P and C) in alcohol solvent and subsequent drying of milled raw materials at 120° C. Finally, the milled raw materials were calcined at 350° C. and 650° C. under N₂/Ar atmosphere to obtain C-LFP composite. Though this invention claims the promising performance of C-LFP composite, the composite like material is nowhere cost competitive compared with solid state synthesized C-LFP composite achieved in the instant invention via simple high energy milling based solid state method without any solvent.

Zhang et al [Electrochimica Acta 55 (2010) 2653] discloses a method of synthesizing C—LiFePO₄ by adopting high-energy ball milling of Li₂CO₃, NH₄H₂PO₄, FeC₂O₄ raw materials with citric acid as organic carbon source followed by thermal treatment. Further, the effects of ball milling process and annealing time on the phase formation, particulate morphology, carbon content, and consequent electrode performance of LifePO₄/C composite were studied. It was concluded that 4 h ball milled C-LFP resulted in the best electrochemical performance due to the proper amount of carbon and proper carbon structure. However, the long milling time, the uses of solvents including acetone, ethanol, toluene, etc. for milling and limited production capability make the process more academic rather than commercial interest.

Mechanical alloying is a basic technique used for milling of homogenous mixture of blended precursors and was used for synthesis of various alloying materials. Particularly, high kinetic horizontal attrition milling unit or vertical attrition milling unit is the one that used for the solid-state milling of composites with realistic of scalability and used for the production of alloys like Fe—Cr, Ni—Cr or milling of high-speed steel for particle size reduction. The high energy milling can be carried out in small shaker mills such as Spex mill for processing a few grams of powder, or in planetary mills for processing 0.1 to 0.5 kg of powder and attritor mills to mill 0.5 kg to about 100 kg of powder. The attritor mills can generate relative velocity of balls similar to planetary mills but with higher throughput. The design and operation of attritor is simple and it is a cost-effective process to carry out high energy ball milling. The main processing principle of milling is to transfer energy from kinetic collision of balls to powder. The continuous collection of milled powders without any wastage and environmentally friendly condition added further advantages to attrition milling (horizontal as well as vertical).

It can be inferred that none of the patents as well as literature matches with the instant invention. Most of the patents were dealt with the synthesis of LFP by wet milling in the presence of a dispersing agent and the synthesis of LFP adopting combined wet-chemical/solid state or wet-chemical/spray drying with long milling and sintering time. Further, reduced atmosphere (H₂+Ar) was used to prevent the oxidation of Fe²⁺ ions and carbon, which expect to increase the production cost of LFP. In contrast, in the present invention, we have adopted attrition milling, in which milling of Li, Fe, P precursors with citric acid, which act as carbon precursor as well complexing agent to prevent the oxidation of Fe²⁺ to Fe³⁺ during heating was carried out without reducing atmosphere. Stearic acid used as process control agent (PCA) to prevent the cold-welding during milling process and later it converts into carbon under Ar atmosphere during annealing process.

### OBJECTIVES OF THE PRESENT INVENTION

The objectives of the invention are:
(i) To develop high performance nano sized carbon coated LiFePO₄ (C-LFP) cathode material having better electrochemical properties in terms of high charge discharge capacity, excellent rate capability and long cyclic stability suitable for high energy as well as high power density lithium-ion battery application.
(ii) To develop a simple, cost effective, energy efficient and scalable technique of attrition milling for synthesizing in-situ carbon coated LiFePO₄, which can be used as a cathode material for Li-ion battery applications.
(iii) To design a simple large-scale process (horizontal as well as vertical attrition milling unit) which involves milling of precursor material and annealing to get the desired single-phase carbon coated LiFePO₄ with improved electronic conductivity cathode.
(iv) To optimize various parameters like blending, method of milling, milling time, annealing time, and carbon content during the process.

### SUMMARY

Though large numbers of processes are available for synthesis of carbon coated LiFePO₄, they (wet chemical, hydrothermal, solvothermal, precipitation, spray drying, etc.) involve highly complicated synthesis procedures, multi-step processes, use of large amount of solvents & toxic chemicals and expensive techniques. The measures followed to overcome the disadvantages of LifePO₄ like poor electronic and ionic conductivity require the addition of one more step, i.e., the requirement of two/multi-step processes making it more complicated and unsuitable for commercial applications. In the instant invention, we developed a simple, economical and energy efficient scalable technique for production of carbon coated LiFePO₄ cathode material by a single step solid state-based method of synthesis using Li₂CO₃, FeC₂O₄, NH₄H₂PO₄ and Citric acid as precursor for Li, Fe, P and C respectively. Though synthesis of C-LFP from Li₂CO₃, FeC₂O₄, NH₄H₂PO₄ and citric acid precursors reported previously by lab scale planetary ball milling, attrition (horizontal as well as vertical) milling process, the most reliable technique for up-scaling without affecting the cost has been adopted by us for the first time to synthesize carbon coated LiFePO₄. According to prior patent art and published literatures, many methods of synthesis involve a two-step procedure wherein initially synthesis of LFP was carried out and later ex-situ carbon coating was done to increase the electronic conductivity. Whereas in the instant invention, we have developed in-situ large scale solid state-based process in which, the synthesis of LFP and carbon coating carried out simultaneously. The citric acid used in the present invention plays a dual role, one as carbon precursor and other as complexing agent to prevent the oxidation of Fe²⁺ to Fe³⁺ during annealing process which is an added advantage compared to other technique. The method followed here provides the ease of up scaling. This method ensures high-cost effectiveness as the precursors used and the equipment handled is highly cost effective. Accordingly, a method of producing high performance carbon coated LiFePO₄ cathode using attrition (horizontal as well as vertical) milling process is disclosed here comprising the following features:

Li₂CO₃, FeC₂O₄, NH₄H₂PO₄ and Citric acid precursors are used as lithium, iron, phosphorous and carbon precursors respectively.

Initially Li₂CO₃, FeC₂O₄, NH₄H₂PO₄ and Citric acid precursors were blended in pot milling.

Later, milling of blended mixture was carried out in horizontal or vertical attrition milling unit at a speed of 250-550 rpm for 2-12 hrs. to reduce the particle size. Ball to powder ratio was maintained as 1:10 employing 5 mm dia. stainless steel balls as milling medium. A process control agent (PCA) is used to prevent the stacking of powders. Here 2-5 wt. % of stearic acid is used as PCA which also acts as carbon source also.

After milling, the powders are discharged and stored for annealing and characterization.

The powder obtained from attritor milling were pelletized using a 100×100 mm die under 0.5-1 ton pressure using a hydraulic press. When in pellet form, it ensures proper inter-particle contact and more heat transfer making annealing uniform throughout.

The resulting pellet is initially annealed at low temperature (350-400° C.) and subsequently heated at high temperature (650-700° C.) to produce highly crystalline carbon coated LFP with smaller particle size. Annealing was carried out in argon or nitrogen atmosphere in pit furnace. The citric acid used in the instant invention plays a dual role, one as carbon precursor and other as complexing agent to prevent the oxidation of Fe²⁺ to Fe³⁺ during annealing process which is an added advantage compared to other technique

Annealed powders were collected and ground to fine powder and stored.

Different citric acid concentrations such as 3%, 5%, 7% and 10% were used to optimize the suitable carbon content required for the synthesis of carbon coated LiFePO₄. The resulting carbon coated LiFePO₄ materials with 3%, 5%, 7% and 10% carbon content in the precursor are referred as C-LFP-3, C-LFP-5, C-LFP-7 and C-LFP-10 respectively.

On characterization of the resultant powders as cathode material for Li-ion battery application, it was found to give excellent electrochemical performance in terms of high specific capacity, high-rate capability and good cyclic stability.

The method of producing high performance nano sized and carbon coated lithium iron phosphate powders for making the cathode for lithium-ion battery, using horizontal or vertical attrition milling comprising the steps of: a) selecting the Lithium carbonate (Li₂CO₃), ferrous oxalate (FeC₂O₄), ammonium dihydrogen orthophosphate (NH₄H₂PO₄) and Citric acid as precursors of Li, Fe, and P respectively as raw material for the process; b) grinding ammonium dihydrogen orthophosphate and citric acid into a fine powder; c) dispersing 0.5-1 wt. % of process control agent, stearic acid into 1.5-2 litres of acetone/isopropanol; d) adding Li₂CO₃ into the resultant solution and dispersing completely; e) adding ammonium dihydrogen orthophosphate and ferrous oxalate into the above dispersion, in such a way that mole ratio of Li:Fe:P raw materials used for the blending is 1.05:1:1, f) adding citric acid into the above dispersion to obtain the final carbon content of 3-10 wt. %; g) adding 2 to 5% stearic acid as process control agent as well as carbon precursor to the above mixture; h) blending the resultant precursor suspension in a ball mill to get the finely mixed slurry without any lumps; i) drying the blended slurry of raw material glass/stainless steel tray at a temperature of 80° C. for 6-12 h along with the balls followed separating the balls from the powder by sieving; J) milling of the blended mixture in horizontal/vertical attrition milling unit maintained with the ball to powder ratio of 10:1-12:1 at a speed of 250-550 rpm for 2-12 hrs; k) discharging the milled powders from horizontal/vertical attrition milling unit on completion of milling and storing them for annealing in dry form; I) pelletizing the milled powder using a 100×100 mm die at a pressure of 0.5-1 ton using a hydraulic press to ensure proper inter-particle contact, better heat transfer, and thus making the process of annealing uniform throughout; m) annealing of the composite milled and pelletized powder under inert atmosphere of argon/nitrogen in a tubular furnace initially at low temperature (350-400° C.) and subsequently heated at high temperature (650-700° C.) with a heating rate of 2-5° C./min. for a period of 2-10 hrs; and n) grinding the annealed pellets to a fine powder and validate its efficiency as cathode material in half/full cell configuration for lithium ion battery application.

In a preferred embodiment under the invention, C-LFP is produced by Horizontal as well as vertical attrition milling unit using Li₂CO₃, FeC₂O₄, NH₄H₂PO₄ and Citric acid are used as lithium, iron, phosphorous and carbon precursors respectively. Citric acid used in the present invention act as carbon precursor as well as complexing agent to prevent the oxidation of Fe²⁺ to Fe³⁺ during heat treatment. The usage of citric acid in the prevent invention eliminates the utilization of reducing gases such as H₂ for the heat treatment process as the carbon present in citric acid produces a reductive atmosphere in the presence of argon and maintain Fe in +2 oxidation state. Presence of Fe²⁺ ions and other metal ions (Li⁺ and P⁵⁺) are interpreted from XPS analysis. FE-SEM was done to find out the particle size and was seen that C-LFP with different carbon content produces smaller particles size of around 100-300 nm. Smaller the particle size, smaller is the lithium-ion diffusion path length, therefore smaller size of C-LFP synthesized in the present invention expect to increase the electrochemical performance of LFP. XRD analysis showed the formation of phase pure olivine phase LiFePO₄ with orthorhombic structure. Carbon sulfur analysis revealed that the carbon content in LFP materials varied from 2.1% to 5.48% by weight when different concentration (3-10 wt. %) of initial carbon precursors used for the synthesis.

According to an aspect of the invention High-performance nano sized carbon coated lithium iron phosphate powders for making the cathode for lithium-ion battery produced by the method as explained above is having core-shell structured with spherical/distorted spherical crystalline LFP particles as core in the range of 100-300 nm with thin layer of carbon coating. The carbon coated on lithium iron phosphate particles is having more of disordered amorphous (sp³) carbon than ordered carbon (sp²).

According to another aspect of the invention said carbon coated lithium iron phosphate powders the surface areas of the C-LFP having 3, 5, 7 and 10% carbon content in the precursor is ranging from 19-38 m²/g and the I_{D}/I_{G} ratios is ranging from 1.35 to 1.46.

In another aspect of the invention electrochemical efficiency of C-LFP is in the range of 135-146 mA hg⁻¹ at 1 C when electrode is tested in half cell configuration.

According to another aspect of the invention electrochemical cyclic stability of the C-LFP electrode having 10% carbon content in the precursor at 1 C current rate exhibit 97% capacity retention after 1000 cycles. Whereas rate capability of the C-LFP electrode having 10% carbon content in the precursor at 10 C current rate exhibit 97% capacity retention after 1500 cycles.

According to yet another aspect of the invention said C-LFP having 5 wt. % carbon content exhibits specific capacity of 146 mAh/g at 1 C with, rate capability of 132 mAh/g at 5 C and cyclic stability of 90-92% specific capacity retention, after 600 cycles.

According to one more aspect of the invention nano sized carbon coated lithium iron phosphate powders after converting into electrode form, when tested in full cell configuration in combination with graphite as anode delivered a capacity of 1.2 mAh with plateau voltage at 3.2 V whereas in combination with lithium titanate as anode delivered a capacity of 0.3-0.7 mAh with plateau voltage at 1.87 V.

### BRIEF DESCRIPTION OF THE DRAWINGS

Other features and advantages of the present invention should become apparent from the following description of the preferred process and read in conjunction with the accompanying drawings, which illustrate, by way of example, the principles of the invention.

FIG. 1: Flow chart showing the synthesis of carbon coated LiFePO₄ by horizontal attrition milling.

FIG. 2A: X-ray diffraction pattern of A-LFP synthesized from Li₂CO₃, FeC₂O₄, NH₄H₂PO₄ and citric acid as lithium, iron, phosphorous and carbon precursors respectively with different concentration of carbon: a) 3%, b) 5%, c) 7% and 10%.

FIG. 2B: X-ray diffraction pattern of C-LFP synthesized using different annealing time: a) 3 h, b) 6 h and c) 10 h.

FIG. 2C: X-ray diffraction pattern of C-LFP synthesized using different milling time (2, 3 and 12 h).

FIG. 2D: X-ray diffraction pattern of C-LFP synthesized in different batches of 10%-C-LFP: a) First batch and b) Second batch.

FIG. 3A-D: FE-SEM image of -LFP with 3% (a), 5% (b), 7% (c), and 10% (d) carbon content.

FIG. 4A-D: HR-TEM image of C-LFP with 5% carbon content.

FIG. 5A-B: Raman spectrum of C-LFP (A) with 3% (a), 5% (b), 7% (c), 10% (d) carbon content and Raman spectrum of carbon (B) extracted from C-LFP.

FIG. 6: XPS analysis of C-LFP with 5% carbon content: A) survey spectrum and wide scan spectrum of B) Fe2p, C) P2p, D) O1s and E) C1s.

FIG. 7A: Electrochemical Performance-Charge-Discharge profile of blended 10%-C-LFP at different current rate.

FIG. 7B: Electrochemical performance Rate capability of blended 10%-C-LFP at different current rate.

FIG. 8A: Electrochemical performance-Charge-Discharge profile of horizontal attritor milled 10%-C-LFP at different current rate.

FIG. 8B: Electrochemical performance-Rate capability of horizontal attritor milled 10%-C-LFP at different current rate.

FIG. 8C: Electrochemical performance-Charge-Discharge profile of horizontal attritor milled 10%-C-LFP at different cycles.

FIG. 8D: Electrochemical performance-Cyclic stability of horizontal attritor milled 10%-C-LFP for longer cycles.

FIG. 9A: Electrochemical performance-Charge-Discharge profile of vertical attritor milled 5%-C-LFP at different current rate.

FIG. 9B: Electrochemical performance-Rate capability of vertical attritor milled 5%-C-LFP at different current rate

FIG. 9C: Electrochemical performance-Cyclic stability of vertical attritor milled 5% C-LFP for longer cycles

FIG. 9D: Electrochemical performance-Charge-Discharge profile of vertical attritor milled large scale (10 kg batch) synthesized 5% C-LFP at different cycles

FIG. 10A: Full-cell electrochemical performance of C-LFP with graphite: Charge-Discharge profile of Commercial LFP vs superior graphite from 0.1 C to 10 C

FIG. 10B: Full-cell electrochemical performance of C-LFP with graphite: Charge-Discharge profile of attritor milled C-LFP vs superior graphite from 0.1 C to 10 C

FIG. 10C: Full-cell electrochemical performance of C-LFP with graphite: Comparison of rate capability

FIG. 10D: Full-cell electrochemical performance of C-LFP with lithium titanate as anode: Charge-Discharge profile of attritor milled C-LFP vs Lithium titanate

FIG. 10E: Full-cell electrochemical performance of C-LFP with lithium titanate as anode: C-rate capability of attritor milled C-LFP vs Lithium titanate at different C-rate.

FIG. 11A: Benchmark studies-comparison of charge-discharge profile of commercial LFP materials with attritor milled 5% C-LFP at 1 C rate: a) C-LFP from the instant invention, b) and c) commercial LFP-1 and commercial LFP-2

FIG. 11B: Benchmark studies-Comparison of cyclic stability of commercial LFP materials with attritor milled 5% C-LFP at 1 C rate: a) C-LFP from the instant invention, b) and c) commercial LFP-1 and commercial LFP-2

### DETAILED DESCRIPTION OF THE INVENTION

In accordance with the invention, high performance in-situ carbon coated lithium iron phosphate (C-LFP) cathode having excellent electrochemical characteristics are developed using Li₂CO₃, FeC₂O₄, NH₄H₂PO₄ and Citric acid as are used as precursors of lithium, iron, phosphorous and carbon respectively by adopting a simple, economical and scalable Horizontal or vertical attrition milling technique to achieve highly conducting LFP. Initially Li, Fe, P and C precursors is milled for 2-12 h at 300-550 rpm.

By maintaining ball to powder ratio of 10:1 with stainless steel ball of 5 mm diameter as milling medium. The powder obtained from attritor milling were pelletized using a 100×100 mm die under 0.5-1 ton pressure using a hydraulic press. The resulting pellet is initially carbonized at low temperature (350-400° C.) and subsequently heated at high temperature (650-700° C.) to produce highly crystalline carbon coated LFP with smaller particle size. The method followed here provides the ease of up scaling and ensures high-cost effectiveness as the precursors used and the equipment handled is highly cost effective.

The preferred embodiments of the process under the invention with particular reference to the drawings are as follows.

Lithium iron phosphate (LFP) as an efficient cathode for lithium-ion battery application, according to the invention is synthesized by a simple, facile, fast, and economical and energy efficient Horizontal attrition milling technique. According to the invention, suitable Li, Fe, P and C precursors are used without further purification or treatment. For synthesis of C-LFP, Li₂CO₃, FeC₂O₄, NH₄H₂PO₄ in the stoichiometric ratio of 1:1:1 with 5 wt % of extra Lithium carbonate to compensate the lithium loss during heat treatment are transferred to the stainless-steel horizontal vial of attrition milling unit. Further, citric acid with different content was added to the above Li, Fe and P precursors to obtain the carbon content of 3, 5, 7 and 10% in the final LFP materials. Stainless steel ball used as grinding media and with the ball to powder ratio of 10:1-12:1 was used for milling. Milling was carried out for a period of 2-12 hrs with appropriate acceleration and deceleration. Speed of milling was controlled at 300 rpm for vertical attrition milling unit and between 250-550 rpm for horizontal attrition milling unit. The capacity of milling vials is about 1-15 Kg per run, which makes it attractive for large-scale production. Stearic acid was added as the process control agent to avoid stacking and the powders after milling were collected in the form of dry powders and stored properly.

The milled powders were then annealed to produce single-phase Lithium iron phosphate cathode. Prior literatures have reported that temperatures above 600° C. results in the formation of crystalline lithium iron phosphate. In the prior art process mixture of gases, i.e., mixture of argon (90%) and hydrogen (5-10%) was used for annealing of lithium iron phosphate. Mixed gas atmosphere is reported to prevent oxidation of Fe²⁺ into Fe³⁺ during annealing of lithium iron phosphate, which is required to synthesize lithium iron phosphate without any impurities. According to the instant invention, C-LFP was synthesized using non-toxic, eco-friendly, cheap Li, Fe, P and C precursors which were available commercially and was used without further purification. Horizontal or vertical attrition milling techniques used in this embodiment of the invention enable proper blending and uniform particle size reduction of Li, Fe, P and C precursors. Due to its high energy produced, it ensures less milling time compared to conventional planetary ball milling technique. The citric acid in the present invention not only acts as carbon source but also helps to prevent the oxidation of Fe²⁺ into Fe³⁺ due to its reducing characteristics. The usage of citric acid in the present invention avoids the usage of reducing hydrogen gas, which is expensive and very difficult to handling during annealing of milled LFP powders. This technique thus enables us to produce an efficient cathode material lithium iron phosphate, which can be very much suitable for lithium-ion battery application.

Another embodiment of the invention is the formation of in-situ carbon coating on LFP by adding carbon precursor into Li, Fe, and P precursors followed milling and annealing processes. Milled lithium iron phosphate precursors are pelletized using 100×100 mm die at a pressure of 0.5-1 ton and this ensures proper inter-particle contact. This makes proper crystallization of the bulk powders. The citric acid present along with argon gas creates reducing atmosphere to prevent the oxidation of Fe²⁺ into Fe³⁺ during high temperature annealing process.

The above embodiment of the present invention facilitates formation of in-situ carbon coated LFP by a simple and economical Horizontal or vertical attrition milling technique. Lithium iron phosphate synthesized under optimized condition of Li, Fe, P, and C precursors and annealing condition exhibit excellent electrochemical performance in terms of rate capability and cyclic stability showing its better role as a promising material in lithium-ion batteries.

Having described the process of the invention in a general way, now we will further illustrate the mode of execution and demonstrate the characteristics/properties of LFP according to the process under the invention and also its electrochemical properties with the help of the following examples. The present invention is, however, not limited to these examples and various embodiments are possible within the scope thereof.

### Example 1

### Synthesis of In-Situ Carbon Coated LiFePO₄:

### Blending of Raw Materials

Lithium carbonate (Li₂CO₃), ferrous oxalate (FeC₂O₄), ammonium dihydrogen orthophosphate and citric acid are used as Li, Fe, P and C raw materials respectively for making carbon coated LiFePO₄. Raw materials particularly, ammonium dihydrogen orthophosphate and citric acid are grinded into a fine powder. Then certain amount (2-5 wt. %) of process control agent added to 1.5-2 litres of either acetone/isopropanol and dissolve completely. Later Li₂CO₃ was added into the above solution and completely dispersed. Subsequently other precursors such as ammonium dihydrogen orthophosphate, citric acid and ferrous oxalate were dispersed. The mole ratio of Li Fe:P raw materials used for the blending is 1.05:1:1. Depending on the required carbon content in the final material (C—LiFePO₄), the citric acid content will be varied between 3-10 wt. %.

Then the resulting precursor suspension subjected to blending using zirconia balls with sizes of 5-6 mm as milling media. The ball to powder ratio maintained was 1:2-1:4. The blending was carried out with the speed between 100-200 rpm for 5-10 h to get the finely mixed slurry without any lumps.

### Drying of Blended Materials:

The wet blended slurry containing raw materials were transferred into glass/stainless steel tray and kept for drying at 80° C. for 6-12 h along with the balls. After drying, the balls were separated by sieving and the resulting powders were used for further processes.

### Milling of Blended Materials:

### Horizontal Attrition Milling:

Milling of blended raw materials was carried out in a horizontal attrition milling unit by maintain the ball to powder ratio of 10:1-12:1. The powders used for milling were in the range of 1-2 kg. Stearic acid used as process control agent and 3 wt. % of stearic acid added to the blended raw materials and was subjected to milling process. Stainless steel balls with sizes of 3-6 mm used as milling media. Initially the powders are blended at a speed of 100 rpm for 0.5 h before high energy milling. Then, the powders are milled at a speed of 200-550 rpm. Later the above process of milling repeated to 40 to 48 times in a pattern by increasing (550 rpm) and decreasing (200 rpm) the speed for a period of 0.5 to 2 hrs. Discharging the milled powders subsequently from horizontal attrition milling unit on completion of milling and storing them for annealing in dry form.

### Vertical Attrition Milling:

Milling of another set of blended raw materials was carried out in a vertical attrition milling unit by maintain the ball to powder ratio of 10:1. The powders used for milling were in the range of 0.5-1 kg. Stearic acid used as process control agent and 3 wt. % of stearic acid added to the blended raw materials and was subjected to milling process. Stainless steel balls with sizes of 5 mm used as milling media. The raw materials along with stearic acid are milled at a speed of 200-300 rpm for 2-12 hrs. Discharging the milled powders subsequently from horizontal attrition milling unit on completion of milling and storing them for annealing in dry form.

### Up-Scaled Milling Process:

10 Kg of blended raw materials were milled in 250 kg capacity vertical attritor milling unit using stainless steel balls with the diameter of 3-6 mm as milling media. The ball to powder ratio maintained was about 10:1.2-3 wt. % stearic acid was used as process control agent and was added to the blended raw materials. The milling was carried out at the speed of 150 rpm for 2-3 h. Discharging the milled powders subsequently from vertical attrition milling unit on completion of milling and storing them for annealing in dry form.

### Compaction of Dry Milled Powders:

After drying, the milled powders of 250-300 g are kept in square die with the dimensions of 100 mm×100 mmx 80 mm (L×W×H). The punches with dimension of 100 mm×100 mm of are kept in the bottom and top of the milled powders. Later, the die kept in automatic hydraulic machine and was pressed with the applied of 1-2 Tons for 5-10s. Finally, 100 mm×100 mm×40 mm (L×W×H) pellet obtained.

### Pre-Heating Process:

15-20 Nos. of LFP compacts are kept in sample holder which is having three horizontal trays. Then this sample holder is kept inside the retort which was wounded with heating coil in order to get the uniform heated length of about 600 mm. After retort is completely closed with top lid which is having vacuum and gas flow control (inlet and outlet) set up, initially evacuation was done with vacuum pump and subsequently inert gas was introduced into the retort. The above process was repeated at least 10 times to remove the atmospheric gases from the retort. Finally, the positive pressure of 0.1 bar maintained within retort to prevent the entry of atmospheric gases into the chamber.

### Heating Process:

Furnace was initially heated from room temperature to 350-400° C. with the heating rate of 2-5° C./min. After temperature reaches 350-400° C., it was held for 2 h. During this temperature of 350-400° C., the flow rate of inert gas was maintained between 2-4 L/min. The gases such as CO₂, CO, and NH₃ which are evolved at this temperature were neutralized by introducing the gas outlet from the furnace into water. Then the temperature increases from 350° C. to 650-700° C. with the heating rate of 3-5° C./min. and held for 3-10 h. The flow rate of inert gas maintained at this temperature was 0.5 L/min. After holding for 10 h, the furnace was cooled to less than 100° C. Then the powder was discharged from the furnace and subsequently weighed to know the material yield after heating process.

### Grinding and Sieving of the Heated Pellets

After discharging the heated pellets from furnace, it was grinded by commercial grinder. Then the powder was subjected to sieve by keeping the powder into 75 and 45 μm mesh size sieves one after another. The particle free LFP powder was finally obtained with the tap density of 0.5-0.7 g/cc.

### Physicochemical Characterization:

The structural, morphological, carbon characteristics and elemental compositions of C—LiFePO₄ were measured by XRD, FE-SEM, HR-TEM, BET, C—S, Particle size analyzer and Raman analysis.

### Electrochemical Characterization:

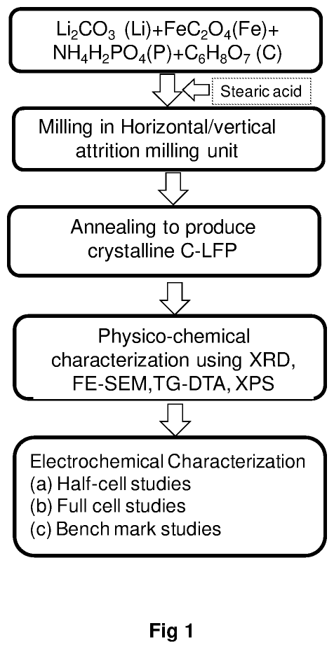

In order to validate the material for Li-ion battery application, initially C-LFP containing electrodes was prepared. For making electrode, C-LFP, polyvinylidene fluoride (PVDF) and carbon black (CB) are mixed in different ratios of 80:10:10, 90:6:4, 92:4:4 respectively. Initially PVDF is dispersed in NMP completely and subsequently CB and C-LFP were added into the above dispersion to obtain slurry. This slurry was later coated on current collector, carbon coated Aluminium foil with wet thickness of about 100-120 μm and then dried at 60° C. and 120° C. to get the dry thickness of about 60-80 μm. The electrode with C-LFP mass loadings of 6-10 mg/cm² was maintained for electrochemical testing. Electrochemical cells were fabricated using 12 mm diameter C-LFP disc as working electrode and 12 mm Li-foil as counter and reference electrode respectively. Electrochemical testing was carried out in half cell configuration by applying different current based on the mass loading of C-LFP. 1M LiPF₆ dissolved in 1:1:1, Ethylene Carbonate:Dimethyl carbonate:Ethyl Methyl Carbonate used as electrolyte for electrochemical testing of C-LFP cells. Graphite and lithium titanate (LTO) has been used as anode electrode when C-LFP was tested in full cell configuration. C-LFP to graphite and C-LFP to LTO mass ratio maintained in electrode is about 1:0.55 and 1:1. The same electrolyte has been used for full cell testing as well and testing was carried out by applying different current based on the mass of LFP electrode. Benchmarking studies were carried out in half and full cell configuration under identical experimental conditions using electrode, which were prepared using commercially available LiFePO₄ material. The schematic illustration for the synthesis of lithium iron phosphate in the present invention is shown in FIG. 1.

### Example 2

### Structural, Elemental and Morphological Characterization of In-Situ Carbon Coated LiFePO₄ by Vertical Attritor Milling Unit

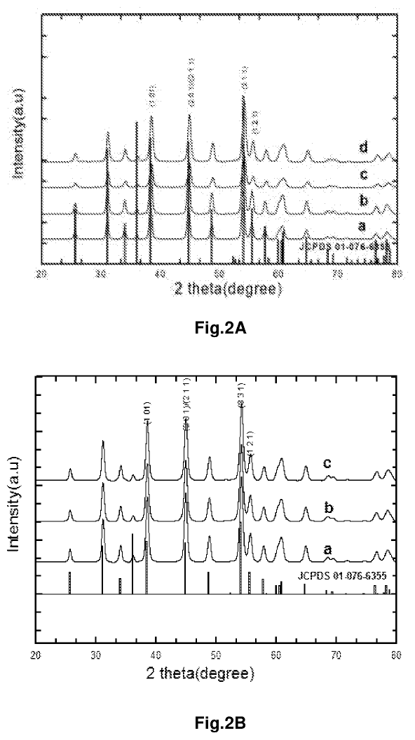

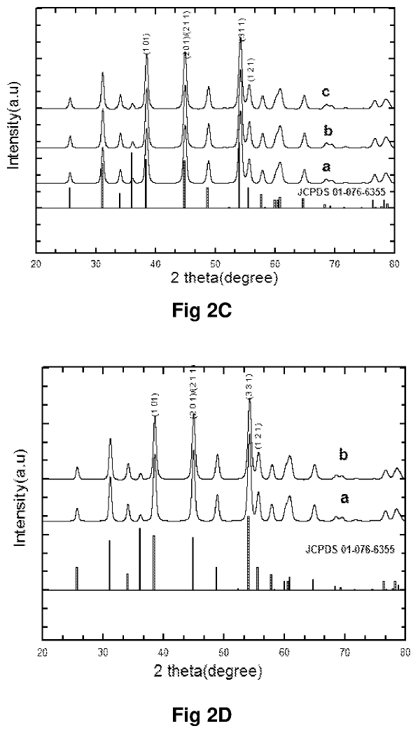

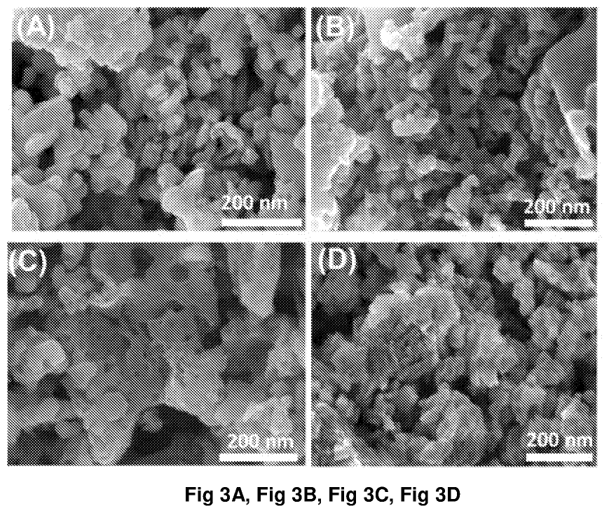

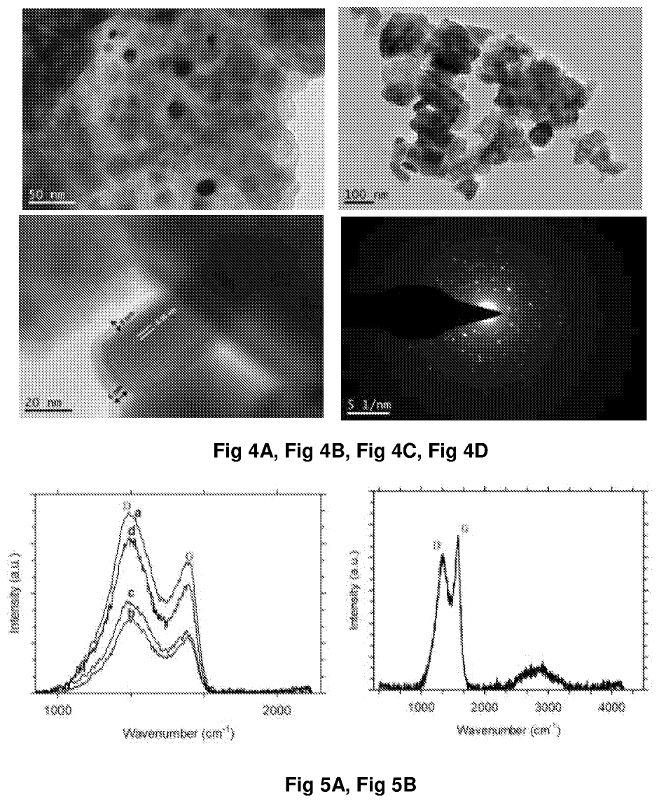

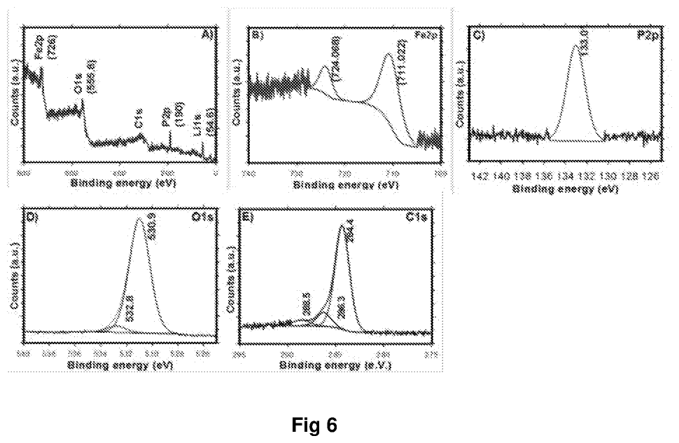

Since the in-situ carbon coated LiFePO₄ obtained by vertical attritor milling unit shown better electrochemical performance, the structural and morphological characterizations were done only for C-LFP synthesized by vertical attritor milling unit. X-ray diffraction studies were carried out to find the phase formation and crystallinity of the material developed using the invented method and is shown in FIG. 2(A-D). The structure of synthesized C-LFP cathode material carbon coated with different carbon weight percentages (3, 5, 7, and 10%), different milling time (2, 3, 10 h), and heat-treated under different annealing time (3, 6 and 10 h), and the material prepared at different batches were measured by X-ray diffraction analysis and the results are shown in FIG. 2(A-D). As shown in FIG. 2(A-D) the major diffraction peaks of all C-LFP materials with different carbon content (FIG. 2A), annealing time (FIG. 2B), milling time (FIG. 2C), and different batches (FIG. 2D) were indexed to match with the diffraction pattern of standard LFP (JCPDS #01-076-6355) belonging to olivine family with orthorhombic crystal system and pnma space group, indicating that phase formation of LFP takes place without the formation of impurities. Further, the sharp peaks indicate that the LFP formed is crystalline. Such a pure phase with high order crystallinity may help to improve the Li-ion battery properties of the developed cathode material. The size and morphology of the C-LFP materials with different carbon content (3, 5, 7, and 10%) were evaluated by field emission scanning electron microscopy and the results are depicted in FIG. 3(A-D). Smaller the particle size, shorter is the lithium-ion diffusion length. Low magnification image of 3% C-LFP in FIG. 3A showed distorted spherical like LFP particle coated with thin carbon layer as well as the presence of agglomerated irregular particles. FIG. 3B showing elongated distorted spherical like morphology for 5% C-LFP with particle sizes in the range of 100-300 nm with agglomeration, and particles with more or less uniform size distribution. 7% C-LFP (FIG. 3C) showed relatively bigger sized particle with porous structure. 10% C-LFP (FIG. 3D) shows agglomerated particles with sizes of <200 nm which contains primary (<100 nm) and secondary sub-micron sized particles (<200 nm) with less agglomeration. It is observed that all C-LFP materials with different carbon content having pattern of sub-micron sized secondary particles which contains nano sized spherical or distorted spherical particles. It is expected that sub-micron sized particle could avoid unwanted parasitic reactions with electrolyte which may result in capacity fading and therefore is expected to perform better in terms of electrochemical performance. The HR-TEM images of 5% C-LFP are shown in FIG. 4A-4D. FIG. 4A clearly shows that nano-sized LFP particles with sizes of 50-100 nm are embedded into the carbon matrix. Carbon layer is seen to form a shell-like structure around LFP which forms the core and similar core-shell structure is observed when checked at different locations of C-LFP. High magnification image of C-LFP (FIG. 4B) show the elongated spherical like particles of LFP in which homogeneous carbon coating was observed. FIG. 4C clearly shows the formation of core-shell structure in which carbon layer (shell) is uniformly coated on nano-sized LiFePO₄ particles (core). The carbon layer thickness found from HR-TEM image is ˜5-6 nm. Such kind of thin layer carbon is very effective for Li-ion diffusion during charging and discharging. Further, electronic conductivity of LFP is expected to increase greatly due to its homogeneous carbon coating on LFP which expects to increase the rate capability. Moreover, the carbon layer around LFP acts as a protective layer to prevent contact with electrolyte and thus prevent LFP dissolution into the electrolyte. It is also seen that LFP is highly crystalline with well-defined fringes. The fringe width of 0.55 nm observed from FIG. 4C is consistent with lattice fringes values of standard LFP. The selected area electron diffraction patterns (SAED) of C-LFP are given in FIG. 4D. SAED pattern of C-LFP exhibits high intensity of rings, which corresponds to the presence of polycrystalline domains in LFP particles as observed in XRD analysis. The degree of graphitization in carbon coated LFP was analyzed by Raman spectroscopic analysis. C-LFP shows two strong peaks at 1350 and 1590 cm⁻¹ which are characteristics of the D-band and G-band, demonstrating the presence of both ordered graphitic carbon and disordered carbon in LFP. The presence of D band and G band is characteristic of the nanocrystalline nature of the carbon. The D band is a disorder-induced peak in sp² Carbon, which can occur due to defects or small crystallite sizes for all amorphous and nanocrystalline carbon films. The G-band (E_{2g}) appears because of the stretching vibration of the C—C bond indicating the graphite lattice mode E_{2g} and represents sp² bonding of carbon, respectively. The D band intensity is higher than the G band intensity for C-LFP [FIG. 5A], indicating the presence of more sp³ hybridized carbon, i.e., the presence of amorphous carbon in LFP in all LFP materials with different carbon content including 3% (a), 5% (b), 7% (c) and 10% (d). The quality of carbon is monitored by calculating the intensity ratio of D and G bands, i.e. (I_{D}/I_{G}) which is used to evaluate the ordered and disordered nature of carbon materials quantitatively. It is reported that a carbon with less I_{D}/I_{G} ratio value leads to formation of more graphitic (sp²) structured carbon in comparison to disordered (sp³) carbon. The I_{D}/I_{G} ratios calculated for C-LFP with different carbon content are 1.46, 1.35, 1.37, and 1.42, implying that 5% carbon coated LFP which is having low I_{D}/I_{G} ratio composed more of ordered carbon (sp²) than disordered carbon (sp³) compared with other CLFP materials. Further Raman analysis was also carried out for the carbon which was extracted after dissolving C-LFP in acid solution. Raman spectrum of the resulting carbon shown in FIG. 5B. Similar to C-LFP, extracted carbon also shows two peaks at 1350 and 1590 cm⁻¹ which are characteristics of the D-band and G-band, demonstrating the presence of both ordered graphitic carbon and disordered carbon in LFP. The I_{D}/I_{G} ratio calculated for C-LFP is 0.9, implying that the extracted carbon is more crystalline than the carbon present in C-LFP composite in which the I_{D}/I_{G} ratio is 1.35. The quantity of carbon in in-situ carbon coated LFP in the present invention was analyzed by C—S analysis. The actual carbon contents after heating measured by C—S analysis are 2.1%, 2.95%, 3.95% and 5.48% for C-LFP material which is having initial carbon precursor percentages of 3%, 5%, &% and 10% for 3% C-LFP, 5% C-LFP, 7% C-LFP and 10% C-LFP respectively. LFP with less and high carbon content would be useful for high energy and high-power Li-ion Battery applications. Further surface area of C-LFP with different carbon content was measured by BET analysis. The surface areas of 3% C-LFP, 5% C-LFP, 7% C-LFP and 10% C-LFP are 19 m²/g, 29 m²/g, 36 m²/g and 38 m²/g respectively. Size distribution of C-LFP with 5% carbon content was measured by particle size analyzer. The D₁₀, D₅₀ and D₉₀ particle sizes of 5% C-LFP are 117±7 nm, 180±10 nm and 285±30 nm respectively. XPS analysis was carried out to find the oxidation state and the corresponding narrow and wide scan spectrum of Fe, P, O and C are shown in FIG. 6. All the spectra were normalized with respect to carbon as reference material. FIG. 6(A) shows the survey spectrum showing the presence of Li, Fe, P and O elements with their respective binding energy characteristics without any other elements as impurities. The peaks obtained at 711 and 724 eV (FIG. 6B) correspond to Fe²⁺ ions and thus ensures that no oxidation has taken place during calcination. The binding energy value of 132.7 eV (FIG. 6C) for phosphorous correspond to P—O bonding. The peak observed at 532.8 eV (FIG. 6D) for O1s corresponds to contamination species adsorbed during measurement. The presence of lattice oxygen and hydroxyl groups is confirmed from O1s spectrum. The binding energies obtained for P and O confirm the presence of (PO₄)³⁻ group, a characteristic of LFP. The peak at 284.4 eV (FIG. 6E) corresponds to sp² hybridization whereas the peaks at higher binding energies (286.3 eV, 288.5 eV) can be assigned to the presence of carboxyl group, indicating that carbon restores C═C bonding and therefore is expected to increase the electrical conductivity of LFP.

### Example 3

### Electrochemical Performance of C-LFP Material Synthesized by Pot Blending, Horizontal and Vertical Attrition Milling Process

Superior electrochemical properties are the final target of the invented technique. The property of C-LFP powder cathode material synthesized by blending, horizontal and vertical attritor milling techniques was tested in half-cell configuration using lithium metal as counter electrode. The crystalline cathode C-LFP material prepared in this invention was used for electrode fabrication to test the efficiency for electrochemical properties.

### Pot Blended C-LFP:

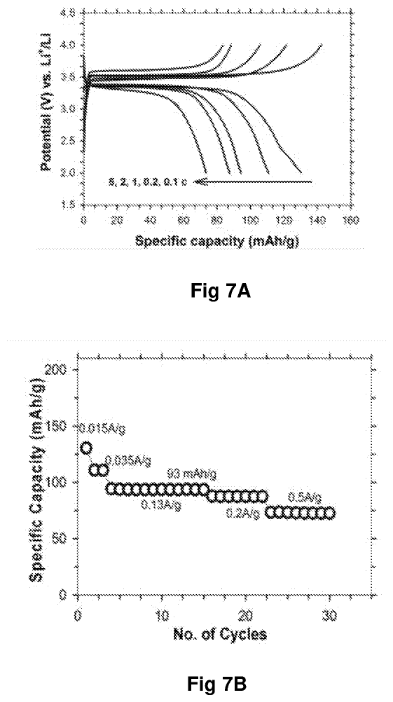

FIG. 7(A-B) shows the electrochemical performance of LFP synthesized using pot blending process. FIG. 7A shows the charge-discharge profile of pot blended 10% C-LFP tested at different C rate. C-LFP (FIG. 7A) delivered a capacity of 142 mA hg⁻¹, 113 mA hg⁻¹, 94 mA hg⁻¹, 88 mA hg⁻¹ and 82 mA hg⁻¹ respectively. The cyclic stability data of C-LFP (FIG. 7B) shows excellent stability though the capacity is less than that of theoretical capacity. Slow lithium-ion diffusion kinetics due to large particle sizes of LFP may be the reason for obtaining less specific capacity for pot blended C-LFP.

### Horizontal Attrition Milled C-LFP

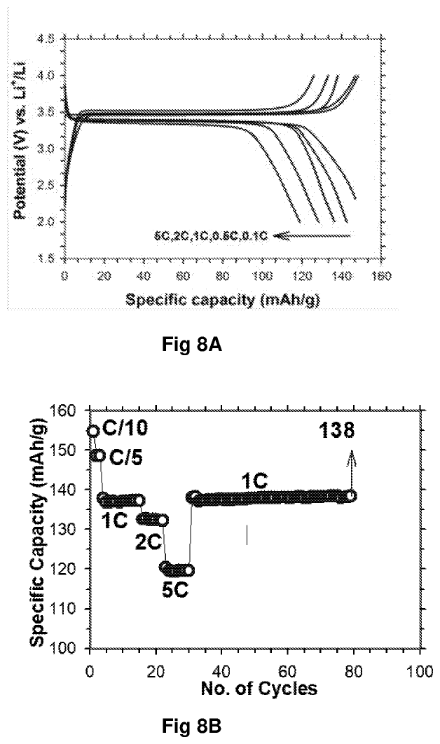

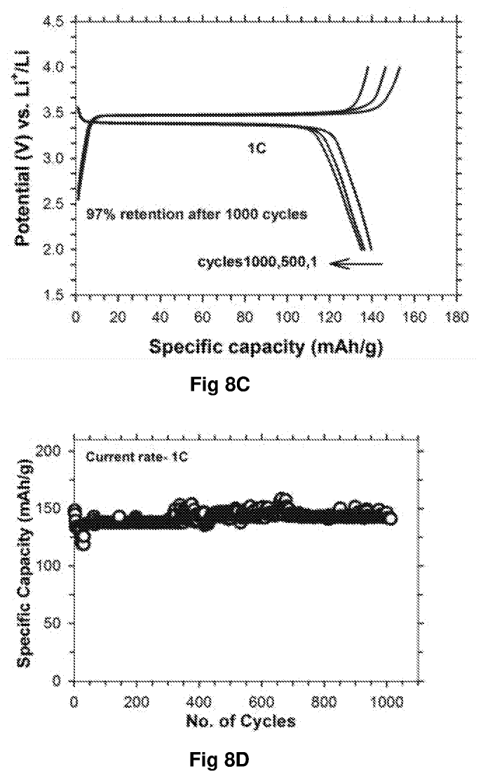

In order to improve the electrochemical performance of C-LFP, horizontal as well as attritor milling technique was adopted for milling of raw materials in order to bring down the particle size further. The resulting milled LFP precursor materials by vertical (kinetic energy of 300 rpm) as well as horizontal (kinetic energy of 550 rpm) attritor technique was subsequently heated to obtain C-LFP. C-LFP processed by high energy horizontal attritor milling unit were tested for charge-discharge cycles and the results are shown in FIG. 8A-8D. Horizontal attritor milled 10% C-LFP delivered a capacity of 152 mA hg⁻¹, 141 mA hg⁻¹, 137 mA hg⁻¹, 128 mA hg⁻¹, and 118 mA hg⁻¹ at 0.1 C, 0.2 C, 1 C, 2 C, and 5 C respectively as shown in FIGS. 8A and 8B respectively. In order to analyze the cycle life, charge-discharge cycles have carried out for longer cycles (1000 cycles) and the resulting charge-discharge profiles and cyclic stability data are shown in FIGS. 8C and 8D respectively. Cyclic stability data reveal that C-LFP material processed by horizontal attritor milling technique exhibit capacity retention of 97% after 1000 cycles.

### Vertical Attrition Milled C-LFP:

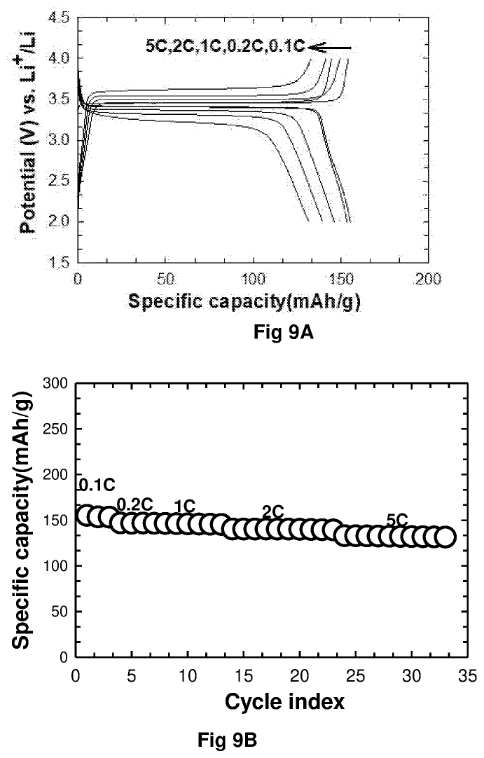

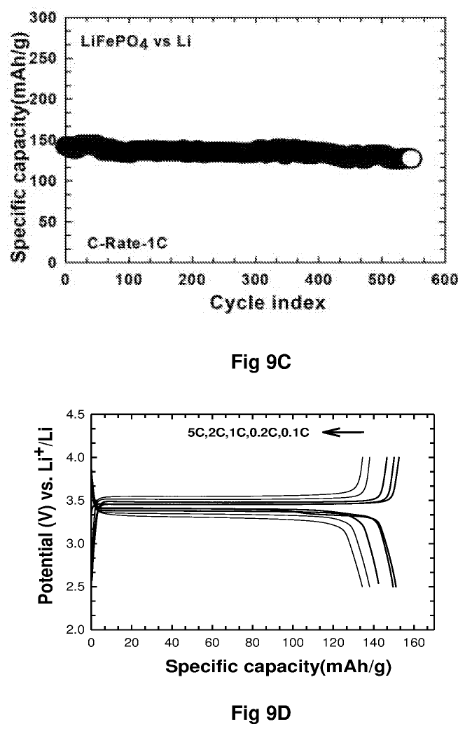

Further, C-LFP material processed by vertical attrition milling unit also tested for Li-ion Battery application. Electrochemical results of vertical attritor milled 10% C-LFP shows capacity of 147 mA hg⁻¹, 144 mA hg⁻¹, 138 mA hg⁻¹, 127 mA hg⁻¹, 117 mA hg⁻¹, and 101 mA hg⁻¹ at 0.1 C, 0.2 C, 1 C, 2 C, 5 C and 10 C respectively. In order to analyze the high-power capability of 10% C-LFP, electrochemical cycles were carried out at 10 C for 1500 cycles. 10% C-LFP capacity retention of 87% after 1500 charge-discharge cycles. In order to optimize the carbon content in LFP powder materials, LFP having different carbon content such as 3%, 5% and 7% was prepared and the resulting C-LFP materials were validated for their electrochemical performance in half cell configuration. 3% C-LFP delivered a capacity of 155 mA hg⁻¹, 153 mA hg⁻¹, 142 mA hg⁻¹, 132 mA hg⁻¹, and 115 mA hg⁻¹ at 0.1 C, 0.2 C, 1 C, 2 C, and 5 C respectively whereas 5% C-LFP exhibited capacity of 155 mA hg⁻¹, 153 mA hg⁻¹, 146 mA hg⁻¹, 139 mA hg⁻¹, and 132 mA hg⁻¹ at 0.1 C, 0.2 C, 1 C, 2 C, and 5 C respectively. 7% and 10% C-LFP delivered capacity of 152 mA hg⁻¹, 148 mA hg⁻¹, 142 mA hg⁻¹, 136 mA hg⁻¹, and 121 mA hg⁻¹ at 0.1 C, 0.2 C, 1 C, 2 C, and 5 C respectively. Among 3%, 5%, 7% and 10% C-LFP, 5% C-LFP showing high specific capacity (FIG. 9A), better rate capability (FIG. 9B) and excellent cyclic stability 90-92% specific capacity retention after 600 cycles, FIG. 9C). The C-LFP material developed in the present invention shows promising electrochemical performance in terms of specific capacity, rate capability and cyclic stability. It is interesting to note that C-LFP synthesized by adopting vertical/horizontal milling technique is showing better electrochemical performance than that of C-LFP synthesized by blending alone, indicating that formation of smaller size particles, which increases Li-ion diffusion kinetics may be the reason for improved performance of the former than the later. Among C-LFP processed by vertical and horizontal attrition milling unit, the electrochemical performance of the former is comparable with the later but at less kinetic energy input, which is attractive for commercial application. Further, C-LFP material synthesized by large scale process (10 kg batch) also tested and the results show that CLFP material delivers 151 mA hg⁻¹, 149 mA hg⁻¹, 146 mA hg⁻¹, 137 mA hg⁻¹, and 134 mA hg⁻¹ at 0.1 C, 0.2 C, 1 C, 2 C, and 5 C respectively and the results are shown in FIG. 9D. Further, cyclic stability data reveals that >90% capacity retention after 600 charge-discharge cycles. It is interesting to note that the developed vertical attrition milling process in the present invention found to be suitable to synthesize battery grade C-LFP material not only in lab scale (1-2 kg batch) level but also in large scale (10 kg batch) level, which is attractive considering the commercial aspect. These results shows that the material developed in the present invention is highly appropriate for commercial applications as it delivered promising performance towards Li-ion battery application as cathode material in terms of rate capability and cyclic stability. The better electrochemical performance delivered by LFP developed in the present invention can be attributed to the presence of uniform carbon coating, smaller particles and the pure phase of LFP.

### Example 4

### Electrochemical Performance in Full Cell Configuration

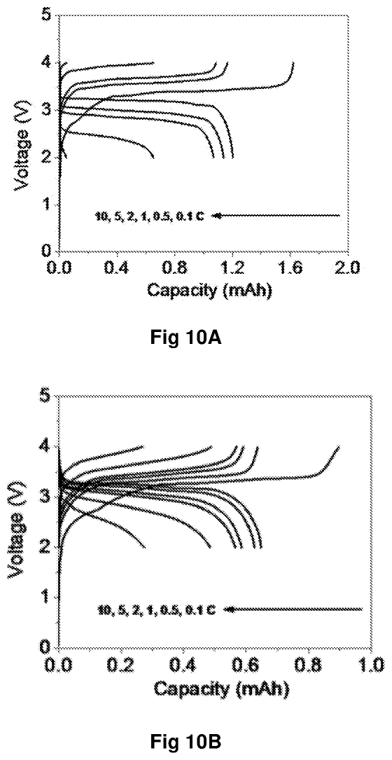

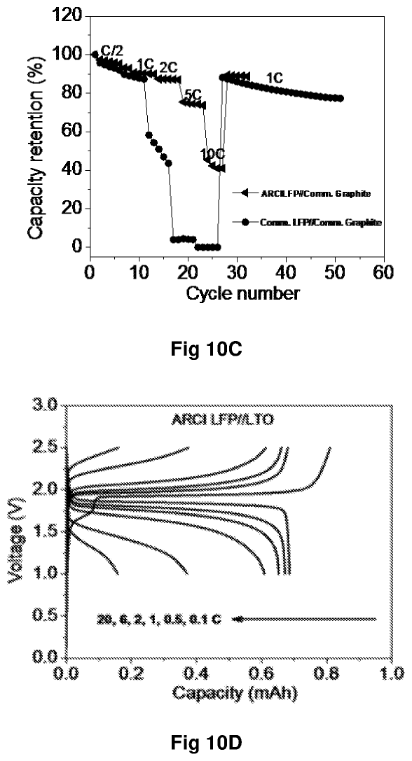

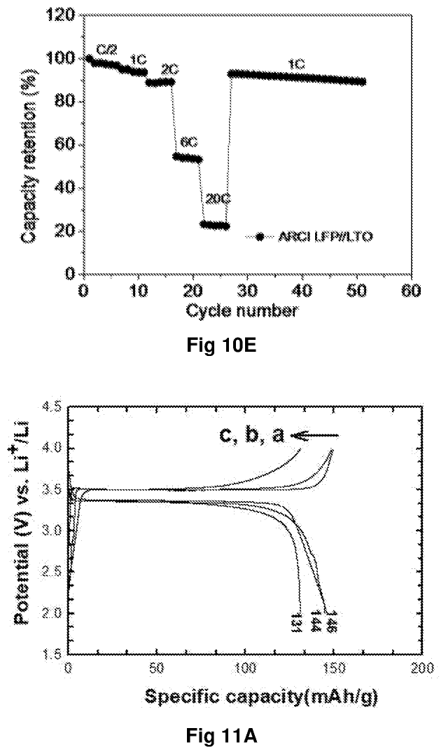

The C-LFP material synthesized by solid state milling method as mentioned in Example 1 was tested for electrochemical efficiency in full cell configuration with combination of graphite as well as lithium titanate as an anode. Before full cell testing, the anode materials were tested in half cell configuration in order to balance the capacity of cathode and anode materials in full cell. Based on the capacity of cathode and anode, mass loading ratio is maintained in full cell between cathode and anode. Charge discharge profile and cyclic stability results reveal that commercial grade C-LFP did not show any high capacity at 5 C and failed to produce the voltage profile which shows the potential of indigenous solid-state C-LFP developed in the present invention. Similarly, commercial graphite has tested for half-cell and it shows 15% irreversible capacity loss in the first cycle. Rate capability studies revealed that superior graphite also found to be suitable for high power Li-ion battery application. Further, full cell studies were carried out with different combination of indigenous and commercial electrode materials. Two full-cells were fabricated as follows: Full-cell 1: Commercial LFP//Superior Graphite; Full-cell 2: Solid state LFP//Superior Graphite and the corresponding charge-discharge profiles are shown in FIGS. 10A and 10B. The large irreversible capacity observed in cell 1 was due to characteristics of commercial LFP as observed in half-cell. However, cell 2 showed less irreversible losses, which is due to the use of indigenous C-LFP. It is clearly evident that the choice of LFP also affects the full-cell performance in terms of irreversible loss and capacity retention. Cell 2 delivered 40% of the initial capacity at 10 C rate. Though cell 1 also retains 40% of capacity at 10 C rate, the capacities obtained up to 5 C are much lower than the cell 1. Of all the combinations of full-cells tested, solid state C-LFP synthesized in the instant invention with superior Graphite as anode seems to be the best combination of LFP//Graphite in delivering high power performance (FIG. 10C).

Full-cell studies were also carried out to find the efficiency of the developed cathode for practical applications. Since LFP vs. LTO forms a promising chemistry for EV applications, C-LFP synthesized in the lab scale was used as cathode. A full-cell was also fabricated using commercial lithium titanate as anode for comparison and the weight ratios of anode to cathode were maintained at 1:3 to compensate for 3 lithium ions that can be accommodated by anode for one ion in cathode and to avoid lithium deficiency resulting from the use of lithium for SEI layer formation. Corresponding electrochemical performance results are shown in FIGS. 10D and 10E. Full-cell with C-LFP as cathode with LTO at different current rate starting from 0.1 C to 10 C rate delivered a capacity of 0.7 mAh to 0.3 mAh with a plateau voltage at 1.87 V which is the signature potential of LFP vs. LTO batteries.

### Example 5

Benchmarks Studies of C-LFP with Commercial LFP

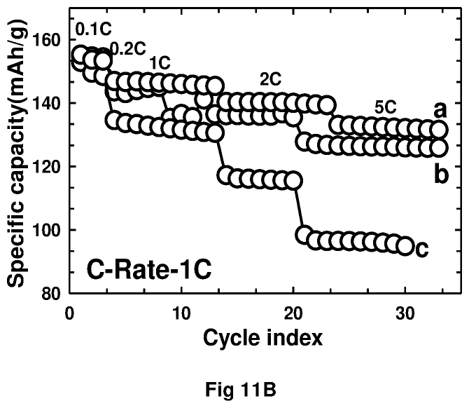

As C-LFP developed in the present invention is found to be efficient in terms of electrochemical performance, benchmark studies were carried out to find the performance of the material for practical applications. Commercial lithium iron phosphate powders were fabricated as thin film electrodes on Aluminium foil using same procedure mentioned in example 3. Then it was cut to 12 mm discs to fabricate half-cell for electrochemical studies. Bench mark studies (FIG. 11A) revealed that the specific capacity of LFP (146 mAh/g) synthesized by vertical attrition milling process (FIG. 11A-a) is higher than the specific capacity (131 mAh/g) of one of commercial LFP-2 (FIG. 11A-c) and on par with the specific capacity (144 mAh/g) of commercial C-LFP-1 (FIG. 11A-b) Rate capability data (FIG. 11B-a) of C-LFP developed in the present invention and commercial LFP powders reveal that C-LFP developed in the present invention exhibit superior electrochemical performance at higher current rate compared with commercial LFP-1 and LFP-2 though all materials exhibit less difference at low current rate. These results indicating that the electrochemical performance of C-LFP developed in the present invention is superior to commercial LFP powders.

We have bought out the novel features of the invention by explaining some of its preferred embodiments thereby enabling any person skilled in the art to understand and visualize our invention. It is also to be understood that the above invention is not limited in its application to the details set forth in the above description or illustrated in the drawings. The phraseology and terminology employed herein are for the purpose of description only and should not be regarded as limiting. Although the invention has been preferred embodiments thereof, variations and modifications can be affected within the scope of the invention as described herein above and as defined in the appended claims.

We claim:

1. A method of producing high performance nano sized carbon coated lithium iron phosphate powders for making the cathode for lithium-ion battery, using horizontal or vertical attrition milling comprising the steps of:
a) selecting the Lithium carbonate (Li₂CO₃), ferrous oxalate (FeC₂O₄), ammonium dihydrogen orthophosphate (NH₄H₂PO₄) and Citric acid as precursors of Li, Fe, and P respectively as raw materials;
b) grinding ammonium dihydrogen orthophosphate and citric acid into a fine powder;
c) dispersing 0.5-1 wt. % of process control agent, stearic acid into 1.5-2 litres of acetone/isopropanol;
d) adding Li₂CO₃ into the resultant solution and dispersing completely;
e) adding ammonium dihydrogen orthophosphate and ferrous oxalate into the above dispersion, in such a way that mole ratio of Li:Fe:P raw materials used for the blending is 1.05:1:1;
f) adding citric acid into the above dispersion to obtain the final carbon content of 3-10 wt. %;
g) adding 2 to 5% stearic acid as process control agent as well as carbon precursor to the above mixture;
h) blending the resultant precursor suspension in a ball mill to get the finely mixed slurry without any lumps;
i) drying the blended slurry of raw material glass/stainless steel tray at a temperature of 80° C. for 6-12 h along with the balls followed separating the balls from the powder by sieving;
j) milling of the blended mixture in horizontal/vertical attrition milling unit maintained with the ball to powder ratio of 10:1-12:1 at a speed of 250-550 rpm for 2-12 hrs;
k) discharging the milled powders from horizontal/vertical attrition milling unit on completion of milling and storing them for annealing in dry form;
I) pelletizing the milled powder with dimension of 100×100×40 mm (L×W×H) using a 100×100×80 mm (L×W×H) die at a pressure of 0.5-1 ton using a hydraulic press to ensure proper inter-particle contact, better heat transfer, and thus making the process of annealing uniform throughout;
m) annealing of the composite milled and pelletized powder under inert atmosphere of argon/nitrogen in a tubular furnace initially at low temperature (350-400° C.) and subsequently heated at high temperature (650-700° C.) with a heating rate of 2-5° C./min. for a period of 2-10 hrs; and
n) grinding the annealed pellets to a fine powder and validate its efficiency as cathode material in half/full cell configuration for lithium-ion battery application.

2. The method of producing high performance nano sized carbon coated lithium iron phosphate powders as claimed in claim 1, wherein stearic acid, 2-5 wt % is added prior to milling to avoid stacking of the nano powders due to cold welding and fracturing during atomistic diffusion.

3. The method of producing high performance nano sized carbon coated lithium iron phosphate powders as claimed in claim 1, wherein the quantity of citric acid added in step f) is varied between 3-10 wt. %.

4. The method of producing high performance nano sized carbon coated lithium iron phosphate powders as claimed in claim 1, wherein while blending in step h) in the ball mill zirconia balls with sizes of 5-6 mm as milling media and ball to powder ratio is maintained between 1:2-1:4.

5. The method of producing high performance nano sized carbon coated lithium iron phosphate powders as claimed in claim 1, wherein spherical/distorted spherical sized LFP particles formed with sizes in the range of 100-300 nm lithium iron phosphate formed.

6. The method of producing high performance nano sized carbon coated lithium iron phosphate powders as claimed in claim 1, wherein during the process of annealing under argon atmosphere in step m), homogeneous thin layer of carbon with thickness of 5-6 nm is getting coated on nanosized lithium iron phosphate particles.

7. The method of producing high performance nano sized carbon coated lithium iron phosphate powders as claimed in claim 1, wherein during the process of annealing under argon atmosphere, core-shell structure of C-LFP formed in which core is LFP and shell is carbon.

8. High-performance nano sized carbon coated lithium iron phosphate powders for making the cathode for lithium-ion battery produced by the method as claimed in claim 1 is core-shell structured with spherical/distorted spherical crystalline LFP particles in the range of 100-300 nm with thin layer of carbon coating over the core.

9. The high-performance nano sized carbon coated lithium iron phosphate powders as claimed in claim 8, wherein the carbon which is coated on lithium iron phosphate particles having the more of disordered amorphous (sp³) carbon than ordered carbon (sp²).

10. The high-performance nano sized carbon coated lithium iron phosphate powders as claimed in claim 8, wherein the tap density of the C-LFP having 3, 5, 7 and 10% carbon content in the precursor is ranging from 0.5-0.7 g/cc.

11. The high-performance nano sized carbon coated lithium iron phosphate powders as claimed in claim 8, wherein the surface areas of the C-LFP having 3, 5, 7 and 10% carbon content in the precursor is ranging from 19-38 m²/g.

12. The high-performance nano sized carbon coated lithium iron phosphate powders as claimed in claim 9, wherein the I_{D}/I_{G} ratios calculated for the C-LFP having 3, 5, 7 and 10% carbon content in the precursor is ranging from 1.35 to 1.46.

13. The high-performance nano sized carbon coated lithium iron phosphate powders as claimed in claim 8, wherein the actual carbon content for the C-LFP having 3, 5, 7 and 10% carbon content in the precursor is ranging from 2.1 to 5.48% (wt).

14. The high-performance nano sized carbon coated lithium iron phosphate powders as claimed in claim 8, wherein electrochemical efficiency of C-LFP is in the range of 135 to 146 mA hg⁻¹ at 1 C when electrode is tested in half cell configuration.

15. The high-performance nano sized carbon coated lithium iron phosphate powders as claimed in claim 8, wherein electrochemical cyclic stability of the C-LFP electrode having 10% carbon content in the precursor at 1 C current rate exhibits 97% capacity retention after 1000 cycles.

16. The high-performance nano sized carbon coated lithium iron phosphate powders as claimed in claim 8, wherein electrochemical rate capability of the C-LFP electrode having 10% carbon content in the precursor at 10 C current rate exhibits 97% capacity retention after 1500 cycles.

17. The high-performance nano sized carbon coated lithium iron phosphate powders as claimed in claim 8, wherein the C-LFP having 5 wt. % carbon content exhibits specific capacity of 146 mAh/g at 1 C with, rate capability of 132 mAh/g at 5 C and cyclic stability of 90 to 92% specific capacity retention, after 600 cycles.

18. The high-performance nano sized carbon coated lithium iron phosphate powders as claimed in claim 8, wherein after the preparation of electrode, when tested in full cell configuration in combination with graphite as anode delivered a capacity of 1.2 mAh with plateau voltage at 3.2 V.

19. The high-performance nano sized carbon coated lithium iron phosphate powders as claimed in claim 8, wherein after the preparation of electrode, when tested in full cell configuration in combination with lithium titanate as anode delivered a capacity of 0.3 to 0.7 mAh with plateau voltage at 1.87 V.
